(19) United States
(12) Patent Application Publication
(10) Pub. No.: US 2026/0106312 A1
(43) Pub. Date: Apr. 16, 2026

(54) Battery Assembly

(71) Applicant: SK On Co., Ltd., Seoul (KR)

(72) Inventors: Jin Woo SON, Daejeon (KR); Kang Seok KIM, Daejeon (KR); Su A KIM, Daejeon (KR); Jae Hyeon BAE, Daejeon (KR); Ye Eun KIM, Daejeon (KR); Ji Hwan KIM, Daejeon (KR)

(21) Appl. No.: 19/350,212

(22) Filed: Oct. 6, 2025

(30) Foreign Application Priority Data
Oct. 8, 2024 (KR) 10-2024-0136267

(51) Int. Cl. H01M 50/342; H01M 50/211; H01M 50/271; H01M 50/289; H01M 50/503

(52) U.S. Cl. CPC H01M 50/3425; H01M 50/271; H01M 50/289; H01M 50/503; H01M 50/211

(57) ABSTRACT

The present disclosure relates to a battery assembly, and a battery assembly according to one embodiment comprises: a battery cell stack comprising a plurality of battery cells; a receiving body configured to retain the battery cell stack, the receiving body comprising a receiving space having at least one open side; and a pad positioned adjacent to the battery cell stack at the one open side.

### CROSS-REFERENCE TO RELATED PATENT APPLICATION

The present application claims priority under 35 U.S.C. § 119 (a) to Korean patent application number 10-2024-0136267 filed on Oct. 8, 2024, in the Korean Intellectual Property Office, the entire disclosure of which is incorporated by reference herein.

### BACKGROUND OF THE INVENTION

### 1. Field

The present disclosure relates to a battery assembly.

### 2. Description of the Related Art

A secondary battery is a battery configured to store electrical energy by converting it into chemical energy and to be reused multiple times through charging and discharging. In order to obtain desired output and performance, a plurality of secondary batteries may be grouped and manufactured into a battery assembly for use. Such a battery assembly may include, as described above, a plurality of secondary batteries, that is, a plurality of battery cells, in an internal receiving space.

When a thermal runaway event occurs in any one of the plurality of battery cells accommodated in the battery assembly, heat or flame generated from the corresponding cell can easily propagate to adjacent cells, which, in such a case, may cause a fatal safety problem due to the characteristics of secondary batteries.

Meanwhile, in order to prevent penetration of external foreign matter into the plurality of battery cells accommodated in the battery assembly or to secure insulation, a pad covering the upper part of the accommodated battery cells may be configured as one element of the battery assembly. However, when such a pad is configured, in the event of a thermal runaway, heat or flame generated from one or more of the battery cells may be confined inside the battery assembly by the pad until the pad is melted or deformed by it, which may cause a fatal problem of further accelerating the thermal runaway phenomenon.

### SUMMARY OF THE INVENTION

According to one aspect of the present disclosure, a battery assembly capable of preventing penetration of foreign matter from the outside and securing internal insulation, and at the same time, rapidly discharging heat or flame through a specific path even if heat or flame occurs in any one of the battery cells, can be provided.

According to another aspect of the present disclosure, a battery assembly with improved safety and stability can be provided.

Meanwhile, the present disclosure can be widely applied to fields of green technology such as Electric Vehicles, Battery Charging Stations, Energy Storage Systems (ESS), Photovoltaics, and Wind Power using batteries. In addition, the present disclosure can be used in eco-friendly mobility including Electric Vehicles and Hybrid Vehicles to prevent climate change by suppressing air pollution and greenhouse gas emissions.

The assembly according to the present disclosure may comprise: a battery cell stack comprising a plurality of battery cells; a receiving body configured to retain the battery cell stack, the receiving body comprising a receiving space having at least one open side; and a pad positioned adjacent to the battery cell stack at the one open side.

In an assembly according to one embodiment, the pad is configured to cover the battery stack at the one open side and comprises one or more first regions and one or more second regions, wherein one or more cut portions may be respectively formed in the one or more first regions.

In an assembly according to one embodiment, the one or more first regions and the one or more second regions may be alternately positioned along a stacking direction of the plurality of battery cells.

In an assembly according to one embodiment, the one or more first regions may each have a first width along the stacking direction, and the one or more second regions may each have a second width along the stacking direction.

In an assembly according to one embodiment, the first width may be 1.5 to 3.5 times the second width.

In an assembly according to one embodiment, the one or more cut portions comprise a plurality of cut portions in the one or more first regions.

In an assembly according to one embodiment, the one or more cut portions may each be independently formed in a continuous shape or a discontinuous shape.

In an assembly according to one embodiment, the battery cell stack may further include one or more barriers respectively inserted between any two adjacent battery cells of the plurality of battery cells, and the pad may cover the battery cell stack such that the one or more first regions overlap the plurality of battery cells and the one or more second regions overlap the one or more barriers.

In an assembly according to one embodiment, the battery assembly may further include a busbar assembly comprising a busbar electrically connecting the plurality of battery cells and a busbar frame supporting the busbar, wherein the busbar frame comprises one or more third regions and one or more fourth regions alternately positioned along the stacking direction of the plurality of battery cells, and one or more openings are respectively formed in the one or more third regions, and the pad may be inserted between the battery cell stack and the busbar frame so as to cover the battery cell stack at the one open side.

In an assembly according to one embodiment, the one or more third regions may each have a third width along the stacking direction, and the one or more fourth regions may each have a fourth width along the stacking direction.

In an assembly according to one embodiment, the third width may be 1.5 to 3.5 times the fourth width.

In an assembly according to one embodiment, the one or more openings include a plurality of openings respectively formed in the one or more third regions.

In an assembly according to one embodiment, the busbar frame may include a pair of first busbar frames extending along the stacking direction and on which the busbar is mounted, and a second busbar frame connecting the pair of first busbar frames, wherein the one or more third regions and the one or more fourth regions are located at the second busbar frame, and the pad may be inserted such that the one or more first regions overlap with the one or more third regions and the one or more second regions overlap with the one or more fourth regions.

In an assembly according to one embodiment, the pad may be inserted such that the one or more cut portions formed in the pad overlap with the one or more openings formed in the busbar frame.

In an assembly according to one embodiment, the pad may be inserted such that, when the pad is orthographically projected, any one of the one or more cut portions is included in any one of the one or more openings that overlap.

In an assembly according to one embodiment, the one or more cut portions may be exposed to the outside through the one or more openings.

In an assembly according to one embodiment, the busbar frame may include a pair of first busbar frames extending along the stacking direction and on which the busbar is mounted, and a second busbar frame connecting the pair of first busbar frames, wherein the one or more third regions and the one or more fourth regions are located at the second busbar frame, and the pad may be inserted such that the one or more first regions overlap with the one or more third regions and the one or more second regions overlap with the one or more fourth regions.

In an assembly according to one embodiment, the battery assembly may further include a receiving cover coupled to the receiving body and covering the opened one side, wherein the receiving cover comprises one or more fifth regions and one or more sixth regions alternately positioned along the stacking direction of the plurality of battery cells, and one or more openings are respectively formed in the one or more fifth regions, and the pad may be inserted between the battery cell stack and the receiving cover to cover the battery cell stack at the one side.

In an assembly according to one embodiment, the pad may be inserted such that the one or more cut portions formed in the pad overlap with the one or more openings formed in the receiving cover.

In an assembly according to one embodiment, the pad may be inserted such that, when the receiving cover is orthogonally projected onto the pad, any one of the one or more cut portions is included in any one of the one or more overlapping openings.

In an assembly according to one embodiment, the one or more cut portions may be exposed to the outside through the one or more openings.

An apparatus for mitigating heat or flame damage to a battery assembly in the event of a thermal runaway according to the present disclosure may comprise: a pad configured to cover a battery cell stack at an open side of a receiving body; wherein the pad comprises one or more first regions and one or more second regions, wherein one or more cut portions may be respectively formed in the one or more first regions.

According to one aspect of the present disclosure, a battery assembly capable of preventing penetration of foreign substances from the outside and securing internal insulation, while simultaneously discharging heat or flame through a specific path promptly even when heat or flame occurs in any one of the battery cells, can be provided.

According to another aspect of the present disclosure, a battery assembly with improved safety and stability can be provided.

Meanwhile, the present disclosure can be widely applied to fields of green technology such as Electric Vehicles, Battery Charging Stations, Energy Storage Systems (ESS), Photovoltaics, and Wind Power, which use batteries. In addition, the present disclosure can be used in eco-friendly mobility including Electric Vehicles and Hybrid Vehicles for preventing climate change by suppressing air pollution and greenhouse fluid emissions.

### BRIEF DESCRIPTION OF THE DRAWINGS

FIG. 1 illustrates an example of an arrangement relationship among components constituting a battery assembly according to an embodiment of the present disclosure.

FIG. 2 illustrates an example of a battery cell stack according to an embodiment of the present disclosure.

FIG. 3 illustrates an example of a pad according to an embodiment of the present disclosure.

FIG. 4 illustrates another example of a pad according to an embodiment of the present disclosure.

FIG. 5 illustrates still another example of a pad according to an embodiment of the present disclosure.

FIG. 6 illustrates yet another example of a pad according to an embodiment of the present disclosure.

FIG. 7 illustrates an example of an arrangement relationship between a pad and a battery cell stack according to an embodiment of the present disclosure.

FIG. 8 illustrates another example of an arrangement relationship among components constituting a battery assembly according to an embodiment of the present disclosure.

FIG. 9 illustrates an example of a region marked with B in a busbar assembly of FIG. 8 as viewed from one side.

FIG. 10 illustrates an example of the battery assembly of FIG. 8 in a coupled state as viewed from a Z-direction.

FIG. 11 illustrates an example of a region marked with C in the battery assembly of FIG. 10 in detail.

FIG. 12 illustrates another example of an arrangement relationship among components constituting a battery assembly according to an embodiment of the present disclosure.

FIG. 13 illustrates an example of a receiving cover according to an embodiment of the present disclosure as viewed from one direction.

FIG. 14 illustrates another example of an arrangement relationship among components constituting a battery assembly according to an embodiment of the present disclosure.

FIG. 15 illustrates a graph showing a voltage drop over time of each of an embodiment and a comparative example of a battery module in a thermal runaway simulation.

### DETAILED DESCRIPTION

The embodiments described in the present specification may be modified into various other forms, and thus, the technology according to an embodiment is not limited to the embodiments described below. Furthermore, throughout the specification, the terms “comprise,” “include,” “contain,” or “have” do not exclude other elements unless otherwise expressly stated, but rather mean that additional elements may be further included, and do not exclude elements, materials, or processes that are not additionally enumerated.

In the present specification, the expression “identical or uniform” may mean that two objects are identical or uniform within an allowable error range, unless otherwise specified. For example, when it is stated that certain structures or physical property measurement values are identical, it may include not only cases where two comparative objects are completely the same, but also cases where they are the same within the error range. Meanwhile, stating that a physical property measurement value is identical may mean that the difference in measurement values between objects is less than about 5%, specifically less than 3%, and more specifically less than 1%.

In the present specification, stating that the angle formed between two objects is perpendicular, or that the two are parallel or aligned, may include not only cases where they are geometrically perpendicular or parallel but also cases where they are within a slight error range.

The numerical ranges used in the present specification include the lower limit and the upper limit, all values within the range, increments logically derived in form and width of the defined range, all doubly limited values, and all possible combinations of upper and lower limits of numerically defined ranges limited in different forms.

Unless otherwise defined in the present specification, the term “about” may be considered as a value within 30%, 25%, 20%, 15%, 10%, or 5% of the specified value.

In the present specification, the use of terms such as “first,” “second,” “third,” and the like in front of components is merely to avoid confusion of the referenced components, and is unrelated to the order, importance, or primary-subordinate relationship among the components. For example, an invention including only a second component without a first component may also be implemented.

In the present specification, “X direction,” “Y direction,” and “Z direction” may be described with reference to a spatial orthogonal coordinate system defined by mutually orthogonal X-axis, Y-axis, and Z-axis. Unless otherwise specified, the Z direction (or third direction) may mean a height direction, the X direction (or first direction) may mean any one direction perpendicular to the height direction, and the Y direction (or second direction) may mean a direction perpendicular to both the Z direction and the X direction. However, the X direction, Y direction, and Z direction mentioned below are described for the purpose of clearly understanding the present disclosure, and it goes without saying that each direction may be defined differently depending on where the reference is set.

In the present specification, the term “electrically connected” may mean, without limitation, all connection methods in which a plurality of objects can be connected so as to be electrically communicated with each other, and may be implemented in various aspects such as the plurality of objects being directly connected to each other or connected through a third object.

In the present specification, a configuration defined as “ . . . portion” may mean, without limitation, a single component or a set of two or more identical or similar components having commonality in terms of function, and the set of components may be configured by an unrestricted combination of hardware and/or software.

In the present specification, the term “disposed” may mean, without limitation, a positional relationship in which one object can be positioned adjacent to another object. By way of non-limiting example, it may mean coating one object on another object, attaching one object to another object via an adhesive material, attaching by applying heat or pressure, simply positioning so that at least a part of one object comes into contact with at least a part of another object within any space, or positioning in a fixed state.

In the present specification, when it is stated that one object “covers” another object, it may mean, without limitation, a functional and structural relationship in which one object is disposed at least adjacent to another object so as to block or mitigate any external factor that may be applied to the other object.

In the present specification, the term “secondary battery” may mean a battery that generates electrical energy through oxidation and reduction reactions when ions, specifically cations such as lithium ions, are inserted into or extracted from the positive electrode and the negative electrode. Specifically, the “secondary battery” may mean any one of a lithium cobalt battery, a lithium high-nickel battery, a lithium iron phosphate battery, a lithium-ion battery, a lithium polymer battery, a lithium-sulfur battery, a nickel-metal hydride battery, a nickel-cadmium battery, a sodium battery, or an all-solid-state battery. More specifically, the term “secondary battery” used in the present specification may mean a lithium-ion secondary battery, but is not necessarily limited thereto.

In the present specification, the term “battery assembly” may be a concept collectively referring to a battery module or a battery pack. Accordingly, the battery assembly according to the present disclosure may not only mean a battery module but also a battery pack that accommodates a plurality of battery cells while omitting a battery module structure, such as a cell-to-pack (CTP).

In the present specification, the term “battery cell” may mean a basic unit of a secondary battery that is capable of charging and discharging electrical energy, including, as main components, an electrode assembly, an electrolyte, and an exterior material.

Hereinafter, the present disclosure will be described in detail. However, this is merely exemplary, and the present disclosure is not limited to the specific embodiments exemplarily described.

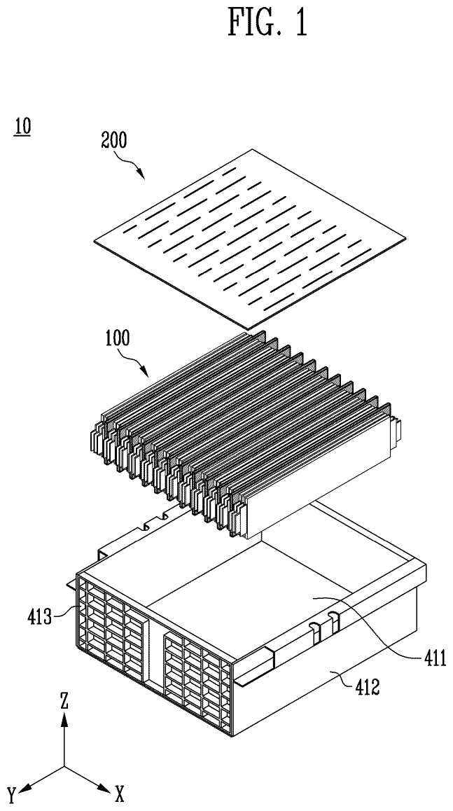

FIG. 1 illustrates an example of an arrangement relationship among components constituting a battery assembly according to an embodiment of the present disclosure.

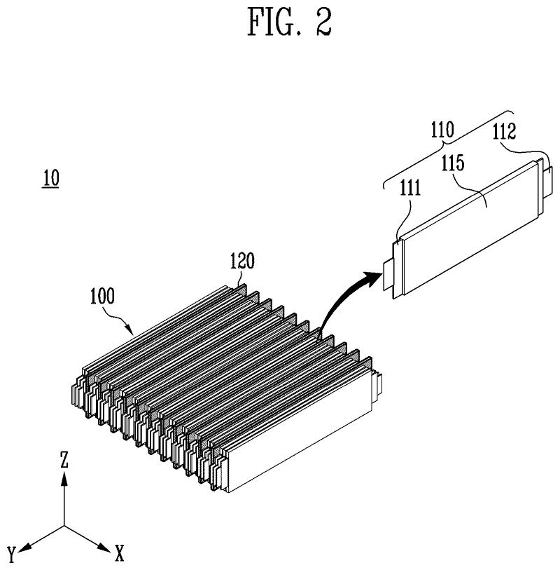

FIG. 2 illustrates an example of a battery cell stack according to an embodiment of the present disclosure.

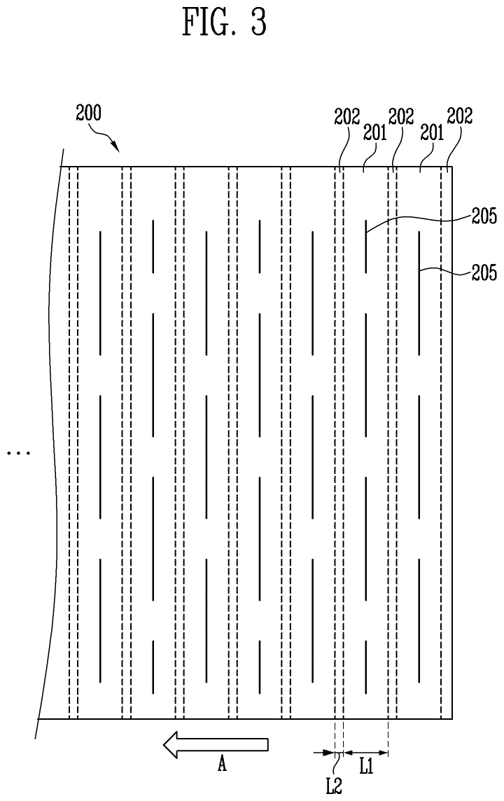

FIG. 3 illustrates an example of a pad according to an embodiment of the present disclosure.

Referring to FIGS. 1 and 2, a battery assembly according to one embodiment of the present disclosure may comprise: a battery cell stack 100 including a plurality of battery cells 110; a receiving body 410 including a receiving space having one open side and receiving the battery cell stack 100 in the receiving space; and a pad 200 covering the battery cell stack 100 at the one side. The pad 200 may comprise one or more first regions 201 and one or more second regions 202, and one or more cut portions 205 are respectively formed in the one or more first regions 201.

In one embodiment, the battery cell stack 100 may comprise a plurality of battery cells 110 stacked in a predetermined stacking direction. That is, in one embodiment, the battery cell stack 100 may mean a stack in which the plurality of battery cells 110 are stacked in the predetermined stacking direction. As will be described later, in one embodiment, the battery cell stack 100 may mean a stack in which the plurality of battery cells 110 and additional components such as a plurality of barriers 120 to be described later are stacked in the predetermined stacking direction.

For example, based on what is shown in FIG. 1, the stacking direction may mean a direction parallel to the X direction.

Referring to FIG. 2, in one embodiment, each of the plurality of battery cells 110 may comprise a body portion 115, which is an exterior material accommodating an electrode assembly (not shown) that produces or stores electrical energy, and lead tab portions 111 and 112 protruding outward from the body portion 115. The body portion 115 may comprise the electrode assembly (not shown) that is electrically connected to the lead tab portions 111 and 112 and produces and stores electrical energy inside.

In one embodiment, the electrode assembly (not shown) may comprise a cathode and an anode.

According to an exemplary embodiment, the cathode may comprise a cathode current collector and a cathode active material coated on at least one surface of the cathode current collector.

According to an exemplary embodiment, the anode may comprise an anode current collector and an anode active material coated on at least one surface of the anode current collector.

According to an exemplary embodiment, the cathode and the anode may further comprise a binder and a conductive material, respectively, for improving mechanical stability and electrical conductivity.

According to an exemplary embodiment, each of the battery cells 110 may further comprise a separator for preventing an electrical short circuit between the cathode and the anode and for allowing ion flow to occur. The separator may comprise, for example, a porous polymer film or a porous nonwoven fabric.

Therefore, in such an embodiment, the electrode assembly (not shown) may have a structure in which the cathode, the separator, and the anode are stacked along a predetermined stacking direction. The cathode, separator, and anode may be stacked in a stacking type, stack-folding type, or Z-stacking type method.

According to an exemplary embodiment, each of the battery cells 110 may comprise an electrolyte inside the body portion 115 to immerse the electrode assembly (not shown). The electrolyte may be a non-aqueous electrolyte. The electrolyte may comprise a lithium salt and an organic solvent, and may further comprise an additive as needed.

Meanwhile, according to another exemplary embodiment, each of the battery cells 110 may further comprise a solid electrolyte layer comprising a solid-state electrolyte. Therefore, in such an embodiment, the electrode assembly (not shown) may have a structure in which the cathode, the solid electrolyte layer, and the anode are stacked along a predetermined stacking direction.

According to an exemplary embodiment, referring to FIG. 2, the body portion 115 may be an exterior material in a film form, at least partially sealed, in a pouch form. That is, the battery cell 110 may be a pouch-type battery cell. However, this is merely exemplary, and unlike what is shown in FIG. 2, the battery cell 110 may also be a prismatic or cylindrical battery cell.

According to an exemplary embodiment, the lead tab portions 111 and 112 may comprise a first lead tab portion 111 and a second lead tab portion 112, which protrude from both side surfaces of the body portion 115 in a direction away from the body portion 115. As one example, the lead tab portions 111 and 112 may also comprise both tabs on one side surface.

In one embodiment, the receiving body 410 may comprise a receiving space opened at one side, and may accommodate the battery cell stack 100 in the receiving space. In one embodiment, the receiving body 410, together with a receiving cover 420 to be described later, may define a receiving case 400 accommodating the battery cell stack 100. The receiving case 400 may be configured to protect the battery cell stack 100 from external shocks such as vibration.

In one embodiment, the receiving body 410 may be provided in a rectangular parallelepiped or cubic shape opened at one side as described above.

In a specific embodiment, the receiving body 410 may comprise a body bottom side 411 forming the bottom side of the receiving space; one or more end plates 413 extending in the one side direction from a pair of corners (not shown) of the body bottom side 411 arranged along the stacking direction; and one or more body side portions 412 provided at both ends of the battery cell stack 100 along the stacking direction. That is, for example, based on what is shown in FIG. 1, the body bottom side 411 may be positioned on the bottom when viewed based on the Z direction, the one or more end plates 413 may be coupled to a pair of corners extending in a direction parallel to the X direction among two pairs of corners of the body bottom side 411, and the one or more body side portions 412 may be coupled to the other pair of corners extending in a direction parallel to the Y direction among the two pairs of corners of the body bottom side 411. That is, in such an embodiment, the one side of the receiving body 410 having such coupling relationships among the above-described configurations may mean the upper side based on the Z direction.

In one embodiment, the pad 200 may cover the battery cell stack 100 at the one side. For example, based on what is shown in FIG. 1, the pad 200 may be configured to cover the battery cell stack 100 at the one side, thereby covering the battery cell stack 100 in the Z direction.

The pad 200, being configured to cover one side of the battery cell stack 100 as described above, may prevent foreign substances from penetrating into the battery cell stack 100 from the outside, and at the same time may secure the insulation of the battery cell stack 100. Furthermore, when at least one of the plurality of battery cells 110 ignites due to a short circuit, deterioration, or the like, thereby causing a thermal runaway situation, the pad 200 may block a path in the one side direction through which flame, heat, and/or high-pressure, high-temperature gas generated by the thermal runaway are directed, thereby suppressing or minimizing heat propagation to other components within the battery assembly 10 or to another battery assembly 10 during the thermal runaway situation.

Referring to FIG. 3, in one embodiment, the pad 200 may include one or more first regions 201 and one or more second regions 202. Meanwhile, in one embodiment, one or more cutting portions 205 may be respectively formed in the one or more first regions 201.

That is, in such an embodiment, the cutting portion 205 is formed only in the first region 201 and may not be formed in the second region 202. In other words, the region in which the cutting portion 205 is formed in the pad 200 may be referred to as the first region 201.

Meanwhile, the first region 201 and the second region 202 may respectively mean virtual regions arbitrarily set on the pad 200. That is, the first region 201 and the second region 202 may be regions that are not physically divided or distinguished on the actual pad 200. In other words, the boundary between the first region 201 and the second region 202 may be a virtual boundary.

Referring to FIGS. 1 to 3, in one embodiment, the one or more first regions 201 and the one or more second regions 202 may be alternately positioned along the stacking direction of the plurality of battery cells 110.

A more detailed description of the first region 201 and the second region 202 will be provided below.

In one embodiment, by the one or more cutting portions 205, one or more gaps may be formed in the pad 200. The cutting portion 205 may be formed by cutting at least a portion of the pad 200 into a predetermined shape using a physical cutting member such as a blade, or by using a laser.

In one embodiment, the cutting portion 205 may exist in a closed shape under general conditions but may be configured to open when pressure is applied by a fluid flowing from outside the pad 200, particularly when pressure is applied toward both wide surfaces of the pad 200.

Accordingly, when at least one of the plurality of battery cells 110 ignites due to a short circuit, deterioration, or the like, thereby causing a thermal runaway situation, the flame, heat, and/or high-pressure and high-temperature gas generated by the thermal runaway may pass through the pad 200 only at the position where the one or more cutting portions 205 are formed, and may not pass through in other regions. Therefore, by allowing the flame, heat, and/or high-pressure and high-temperature gas to pass only through the one or more cutting portions 205, the pad 200 may regulate the path of the flame, heat, and/or high-pressure and high-temperature gas directed from the battery cell stack 100 in the one side direction to a predetermined path when a thermal runaway situation occurs.

Referring again to FIG. 3, in one embodiment, the one or more first regions 201 may each have a first width L1 along the stacking direction, and the one or more second regions 202 may each have a second width L2 along the stacking direction.

As described above, the one or more first regions 201 and the one or more second regions 202 may be alternately positioned along the stacking direction on the pad 200. Meanwhile, for example, based on what is illustrated in FIG. 3, the one or more first regions 201 and the one or more second regions 202 may be alternately positioned along the A direction on the pad 200. In this case, the A direction may be parallel to the stacking direction of the battery cell stack 100 in the battery assembly 10 to which the pad 200 is applied.

In one embodiment, at least a portion of the one or more first regions 201 may have a first width L1 along the stacking direction, and at least a portion of the one or more second regions 202 may have a second width L2 along the stacking direction. In a specific embodiment, all of the one or more first regions 201 may have the first width L1 along the stacking direction, and at least a portion of the one or more second regions 202 may have the second width L2 along the stacking direction. In a more specific embodiment, all of the one or more first regions 201 may have the first width L1 along the stacking direction, and all of the one or more second regions 202 may have the second width L2 along the stacking direction, but it is not necessarily limited thereto.

According to such an embodiment, the pad 200 may be divided along the stacking direction as the second region 202-the first region 201-the second region 202-the first region 201- . . . -the second region 202. Meanwhile, in a specific embodiment, each of the first regions 201 divided as described above may have the first width L1. Meanwhile, in a specific embodiment, among the second regions 202 divided as described above, all of the second regions 202 except the second regions 202 located at both ends may have the second width L2. Alternatively, each of the second regions 202 divided as described above may all have the second width L2.

In one embodiment, the pad 200 may be divided into 25 virtual columns along the stacking direction. In this case, 12 first regions 201 and 13 second regions 202 may be alternately positioned along the stacking direction of the pad 200.

In one embodiment, the pad 200 may be divided into 37 virtual columns along the stacking direction. In this case, 18 first regions 201 and 19 second regions 202 may be alternately positioned along the stacking direction of the pad 200.

In one embodiment, the pad 200 may be divided into 29 virtual columns along the stacking direction. In this case, 14 first regions 201 and 15 second regions 202 may be alternately positioned along the stacking direction of the pad 200.

Referring again to FIG. 3, in one embodiment, the first width L1 may be 1.5 times to 3.5 times the second width L2.

In a specific embodiment, the first width L1 may be 1.5 times to 2.5 times the second width L2.

In a specific embodiment, the first width L1 may be 2.5 times to 3.5 times the second width L2.

In such an embodiment, as will be described below, the pad 200 may cover the battery cell stack 100 such that one or more first regions 201 overlap with the plurality of battery cells 110, and one or more second regions 202 overlap with one or more barriers 120.

In one embodiment, a plurality of cut portions 205 may be respectively formed in the one or more first regions 201.

In one embodiment, shapes of the plurality of cut portions 205 may be independent from each other.

FIG. 3 illustrates an example in which three or four cut portions 205 are formed in each of the first regions 201. However, this is arbitrary, and various numbers of cut portions 205 in various shapes may be independently formed in each of the first regions 201 as needed.

In one embodiment, the plurality of cut portions 205 may be formed in the one or more first regions 201 along a direction perpendicular to the stacking direction.

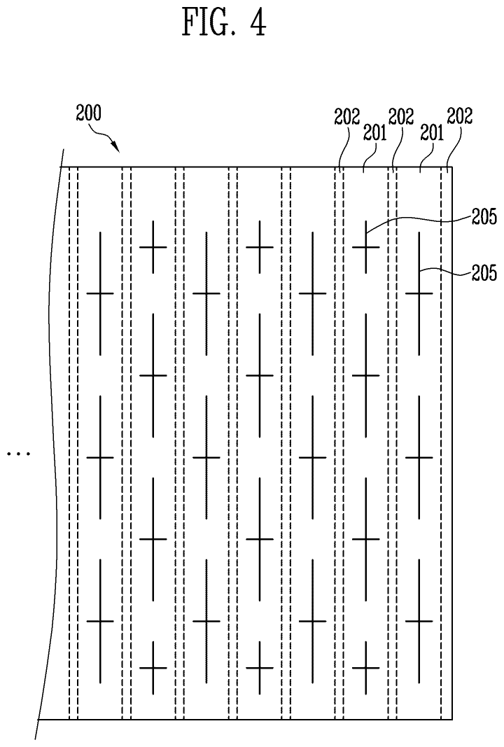

FIG. 4 illustrates another example of a pad according to an embodiment of the present disclosure.

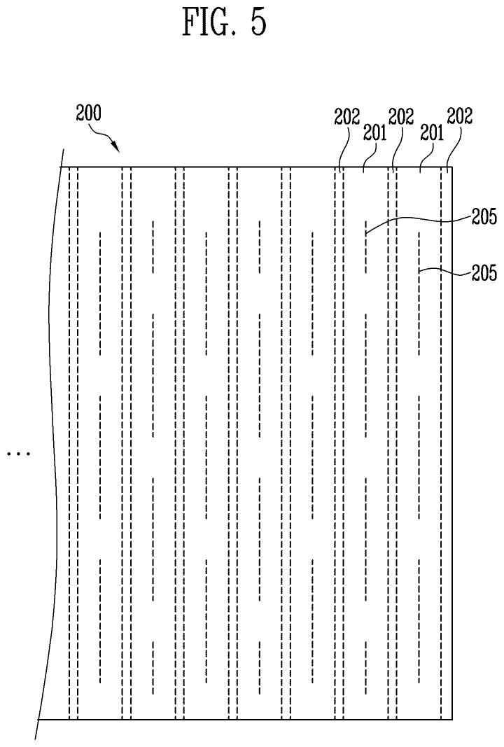

FIG. 5 illustrates still another example of a pad according to an embodiment of the present disclosure.

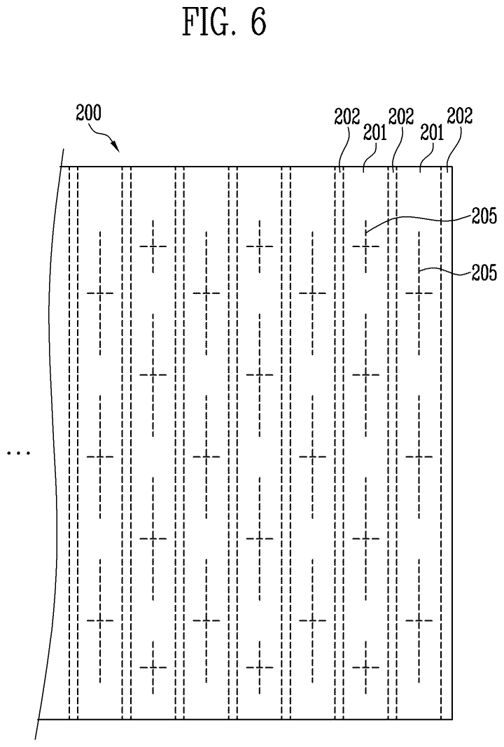

FIG. 6 illustrates yet another example of a pad according to an embodiment of the present disclosure.

In one embodiment, the one or more cut portions 205 may each be independently formed in a continuous shape or a discontinuous shape.

In one embodiment, at least one of the one or more cut portions 205 may be formed in a continuous shape.

In one embodiment, when any one cut portion 205 is formed in a continuous shape, it may mean that the cut portion 205 is continuously connected over the entire cut region (i.e., a region penetrating through one surface and the other surface of the pad 200).

Referring to FIG. 3, in one embodiment, at least one of the one or more cut portions 205 may be Meanwhile, referring to FIG. 4, in one embodiment, at least one of the one or more cut portions 205 may be formed in a shape in which two continuous lines intersect each other at one point. In such a case, at least one of the one or more cut portions 205 may be formed in a continuous cross shape or a continuous X shape, but is not necessarily limited thereto.

In one embodiment, at least one of the one or more cut portions 205 may be formed in a discontinuous shape.

In one embodiment, at least one of the one or more cut portions 205 may be formed in a discontinuous shape.

In one embodiment, when any one cut portion 205 is formed in a discontinuous shape, it may mean that at least a part of the cut region (i.e., a region penetrating through one surface and the other surface of the pad 200) is not continuously connected over the entire cut portion 205.

That is, in such a case, the portion discontinuously formed in the one cut portion 205 may mean that, when the pad 200 is viewed from one surface, it may be formed in the form of a dotted line.

Referring to FIG. 5, in one embodiment, at least one of the one or more cut portions 205 may be formed in a shape of a discontinuous line.

Meanwhile, referring to FIG. 6, in one embodiment, at least one of the one or more cut portions 205 may be formed in a shape in which two discontinuous lines intersect each other at one point. In such a case, at least one of the one or more cut portions 205 may be formed in a discontinuous cross shape or a discontinuous X shape, but is not necessarily limited thereto.

In one embodiment, at least one of the one or more cut portions 205 may be formed such that a part thereof has a continuous shape and the remaining part thereof has a discontinuous shape.

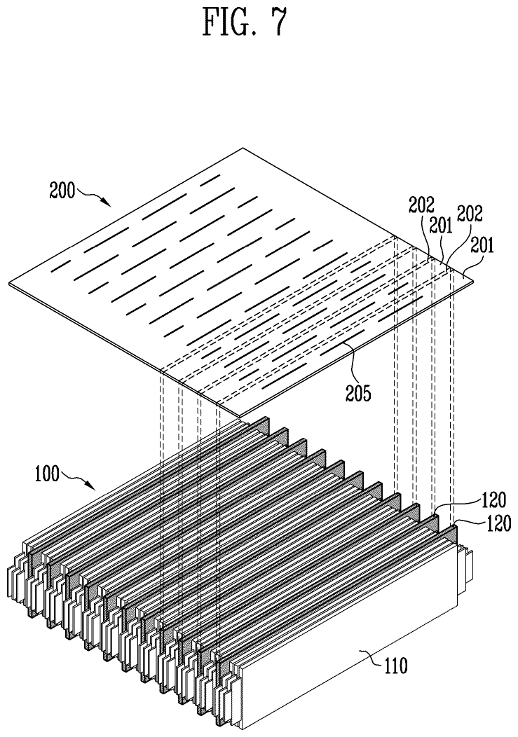

FIG. 7 illustrates an example of an arrangement relationship between a pad and a battery cell stack according to an embodiment of the present disclosure.

In one embodiment, the battery cell stack 100 may further include one or more barriers 120 respectively inserted between any two adjacent battery cells 110 among the plurality of battery cells 110, and the pad 200 may cover the battery cell stack 100 such that the one or more first regions 201 overlap with the plurality of battery cells 110 and the one or more second regions 202 overlap with the one or more barriers 120.

In one embodiment, the battery cell stack 100 may include one or more barriers 120.

Referring to FIG. 2 described above, in one embodiment, the one or more barriers 120 may be inserted between any two adjacent battery cells 110 so that, when at least one of the plurality of battery cells 110 ignites due to a short circuit, deterioration, or the like, thereby causing a thermal runaway situation, the barriers 120 block a movement path in the stacking direction of the battery cells 110 of flame, heat, and/or high-pressure and high-temperature gas generated due to the thermal runaway, thereby blocking or minimizing thermal propagation to adjacent battery cells 110.

In one embodiment, the barrier 120 may have thermal insulation, heat resistance, insulation, and/or fire resistance so as to perform the thermal propagation blocking or minimizing function as described above.

In one embodiment, the barrier 120 may include at least one selected from fiber and inorganic material.

In one embodiment, the fiber may include at least one selected from inorganic material fiber and organic material fiber. In a specific embodiment, the inorganic material fiber may include at least one selected from silica fiber, alumina fiber, silica-alumina fiber, glass fiber, ceramic fiber, and basalt fiber, and the organic material fiber may include aramid fiber.

According to an exemplary embodiment, the fiber may have a form of long fiber or short fiber. When the fiber has a form of long fiber, the barrier 120 may include a woven form of fibers. Through the woven form, the barrier 120 may be configured to include woven fabric or NCF fabric, but is not necessarily limited thereto. Meanwhile, the short fiber may correspond to one not including long fiber. The diameter, length, and the like of the long fiber and/or short fiber are not particularly limited.

In one embodiment, the inorganic material may include at least one selected from a group consisting of mica, graphite, aluminum hydroxide, magnesium hydroxide, wollastonite, and aerogel.

In one embodiment, the barrier 120 may have thermal insulation, heat resistance, insulation, and/or fire resistance, and may include a material capable of sealing a movement path of heat or flame by expanding when in contact with heat or flame. To this end, the barrier 120 may include a thermally expandable material.

In one embodiment, the thermally expandable material may expand to a volume of 150% to 800% relative to its volume at room temperature at a temperature of 150° C. to 300° C.

In one embodiment, the thermally expandable material may include at least one selected from a group consisting of expandable graphite, silicate, and phosphorus-based flame retardant.

In one embodiment, the silicate may include at least one selected from a group consisting of sodium silicate, potassium silicate, and lithium silicate.

In one embodiment, the barrier 120 may include a surface pressure material to perform a surface pressure function of alleviating/offsetting pressure applied to an adjacent cell due to physical deformation when a swelling phenomenon occurs in any one of the battery cells 110 during continuous use of the battery. To this end, the surface pressure material may include an elastic material that is compressed when an external force is applied and restored when application of the external force is terminated.

In one embodiment, the elastic material may include at least one selected from a group consisting of silicone, polyurethane (PU), acrylic, EPDM (Ethylene-Propylene Diene Monomer), EVA (Ethylene Vinyl Acetate), isoprene rubber, butadiene-based rubber, chloroprene rubber, and butyl rubber. In one embodiment, the butadiene-based rubber may refer to butadiene rubber (BR), styrene-butadiene rubber (SBR), acrylonitrile-butadiene rubber (NBR), ABS resin, and the like.

In one embodiment, the one or more barriers 120 may be inserted between any two adjacent battery cells 110 among the plurality of battery cells 110.

In one embodiment, the plurality of battery cells 110 may be stacked such that one barrier 120 is disposed for every two battery cells 110 along the stacking direction. In this case, the battery cell stack 100 may be a stack 100 having a stacking form of . . . -two battery cells 110-barrier 120-two battery cells 110-barrier . . . .

In one embodiment, the plurality of battery cells 110 may be stacked such that one barrier 120 is disposed for every three battery cells 110 along the stacking direction. In this case, the battery cell stack 100 may be a stack 100 having a stacking form of . . . -three battery cells 110-barrier 120-three battery cells 110-barrier . . . .

In one embodiment, unlike the above, the plurality of battery cells 110 may be stacked such that one barrier 120 is disposed for every four battery cells 110 along the stacking direction, or stacked such that one barrier 120 is disposed for every six battery cells 110, or stacked such that one barrier 120 is disposed for every eight battery cells 110.

In one embodiment, the plurality of battery cells 110 may be grouped into a logical unit, which is one unit electrically connected to each other, by grouping one or more adjacent battery cells 110 in the battery cell stack 100. For example, a plurality of battery cells 110 within one logical unit may be arranged with the same polarity and may be connected in parallel. Accordingly, the battery cell stack 100 may be distinguished as one or more logical units. In this case, each logical unit may be configured to have an arrangement of poles different from that of an adjacent logical unit.

In one embodiment, the battery cell stack 100 may be stacked such that one or more barrier 120 is disposed between adjacent logical units among the one or more logical units. For example, when stacked such that one barrier 120 is disposed for every two battery cells 110 along the stacking direction as described above, two battery cells 110 positioned between two adjacent barriers 120 may constitute one logical unit. Alternatively, for example, when stacked such that one barrier 120 is disposed for every three battery cells 110 along the stacking direction as described above, three battery cells 110 positioned between two adjacent barriers 120 may constitute one logical unit.

However, the present disclosure is not necessarily limited to the matters disclosed above, and, for example, four battery cells 110 (or six battery cells 110, etc.) positioned between three adjacent barriers 120 may constitute one logical unit, or six battery cells (or nine battery cells 110, etc.) positioned between four adjacent barriers 120 may constitute one logical unit.

Referring to FIG. 7, in one embodiment, the pad 200 may cover the battery cell stack 100 such that the one or more first regions 201 overlap with the plurality of battery cells 110, and the one or more second regions 202 overlap with the one or more barriers 120.

As described above with reference to FIG. 1, the pad 200 may be disposed to cover the battery cell stack 100 from one surface of the receiving space.

Accordingly, in one embodiment, the one or more first regions 201 overlapping with the plurality of battery cells 110 may mean that the pad 200 is positioned such that the battery cells 110 are covered at one surface by the first regions 201 of the pad 200. For example, based on what is illustrated in FIG. 7, at least a part of the plurality of battery cells 110, and more specifically all of the plurality of battery cells 110, may be configured to contact any one of the first regions 201 on the pad 200 in the Z direction. In other words, in the pad 200, the region that contacts the plurality of battery cells 110 in the Z direction may be referred to as the first region 201.

Meanwhile, in a more specific embodiment, the one or more first regions 201 may be configured to overlap with the logical units. In such an embodiment, each of the first regions 201 may be configured to overlap with one of the logical units. In this case, one of the logical units may be configured to contact any one of the first regions 201 on the pad 200 in the Z direction.

Meanwhile, in one embodiment, that the one or more second regions 202 overlap with the one or more barriers 120 may mean that the pad 200 is positioned such that the barriers 120 are covered at one surface by the second regions 202 of the pad 200. For example, based on what is illustrated in FIG. 7, at least a part of the one or more barriers 120, and more specifically all of the one or more barriers 120, may be configured to contact any one of the second regions 202 on the pad 200 in the Z direction. In other words, in the pad 200, the region that contacts the one or more barriers 120 in the Z direction may be referred to as the second region 202.

Meanwhile, the pad 200 may include one or more first regions 201 and one or more second regions 202 alternately positioned along the stacking direction, and as described above with reference to FIGS. 1 to 6, one or more cut portions 205 may be respectively formed in the one or more first regions 201.

Accordingly, the one or more cut portions 205 may be formed only in a region of the pad 200 that overlaps with the plurality of battery cells 110. In other words, in the battery assembly 10, the one or more cut portions 205 may be formed in portions of the pad 200 that contact the plurality of battery cells 110. More specifically, as described above, in the battery assembly 10, the one or more cut portions 205 may be formed in portions of the pad 200 that contact any one of the logical units. By this, when at least any one of the plurality of battery cells 110 ignites due to a short circuit, degradation, or the like, thereby causing a thermal runaway situation, flames, heat, and/or high-pressure and high-temperature gas generated by the thermal runaway may pass only through the one or more cut portions 205 formed in the one or more first regions 201 positioned to overlap with the plurality of battery cells 110. Thus, at the occurrence of a thermal runaway situation, the pad 200 may regulate the path of flames, heat, and/or high-pressure and high-temperature gas directed from the battery cell stack 100 toward the one surface to a predetermined path.

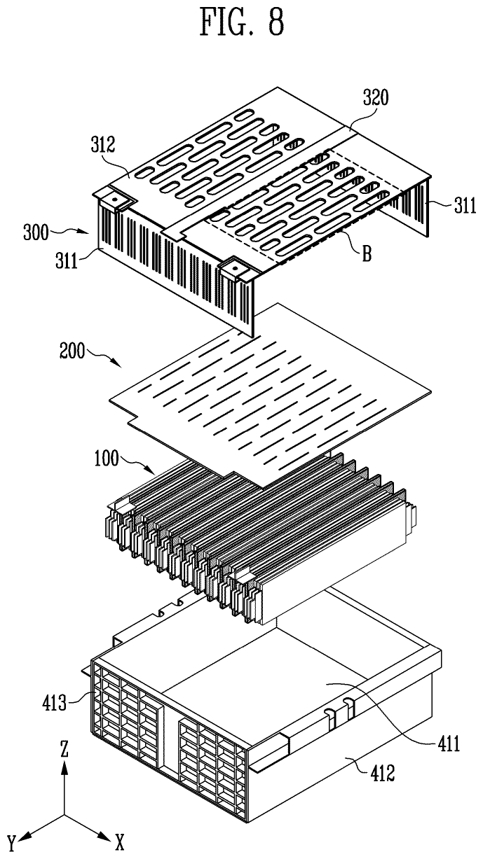

FIG. 8 illustrates another example of an arrangement relationship among components constituting a battery assembly according to an embodiment of the present disclosure.

Referring to FIG. 8, in one embodiment, the battery assembly 10 further includes a busbar assembly 300 comprising a busbar electrically connecting the plurality of battery cells 110 and a busbar frame 310 supporting the busbar. The busbar frame 310 includes one or more third regions 301 and one or more fourth regions 302 alternately positioned along the stacking direction of the plurality of battery cells 110, and one or more openings 305 are respectively formed in the one or more third regions 301. The pad 200 may be inserted between the battery cell stack 100 and the busbar frame 310 so as to cover the battery cell stack 100 from the one surface.

In one embodiment, the battery assembly 10 may further include the busbar assembly 300. In one embodiment, the busbar assembly 300 may include a busbar electrically connecting the plurality of battery cells 110 and a busbar frame 310 supporting the busbar. That is, in one embodiment, the configuration including the busbar and the busbar frame 310 may be referred to as the busbar assembly 300.

In one embodiment, the busbar assembly 300 may be configured to be electrically connected to the outside in order to store (or charge) electric energy in the plurality of battery cells 110 or to supply (or discharge) the electric energy stored in the plurality of battery cells 110 to the outside.

As described above with reference to FIG. 2, each of the plurality of battery cells 110 may include a body portion 115 accommodating an electrode assembly (not shown) therein, and lead tab portions 111 and 112 electrically connected to the electrode assembly (not shown), protruding outward from the body portion 115, and electrically connecting the electrode assembly (not shown) to an external component. Meanwhile, as exemplified in the foregoing description, the lead tab portions 111 and 112 may protrude from both side surfaces of the body portion 115 in a direction away from the body portion 115, or may include a first lead tab portion 111 and a second lead tab portion 112 protruding in the same direction from one side surface and spaced apart from each other.

In one embodiment, the busbar may be electrically connected to at least a part of the lead tab portions 111 and 112 provided in each of the battery cells 110. In a specific embodiment, the busbar may be electrically connected to all of the lead tab portions 111 and 112 provided in each of the battery cells 110 constituting one logical unit. To this end, the busbar may be provided as a plurality. Meanwhile, to this end, the busbar may extend in one direction and may include a plurality of slits, and the lead tab portions 111 and 112 provided in the battery cells 110 constituting each logical unit may be electrically connected by being inserted and coupled into the plurality of slits formed in the busbar. For example, based on what is illustrated in FIG. 1 or FIG. 8, the busbar may be disposed in the battery assembly 10 in a form extending in the stacking direction (X-direction). Alternatively, the busbar may be disposed in the battery assembly 10 in a form extending in the same direction as the extending direction of the end plate 413.

In one embodiment, the busbar frame 310 may be configured to fix the position of the busbar within the battery assembly 10 by supporting the busbar. Meanwhile, the busbar frame 310 may also be configured to perform a role of supporting the plurality of battery cells 110 at the one surface. That is, for example, based on what is illustrated in FIG. 1 or FIG. 8, the busbar frame 310 may also be configured to perform a role of supporting the plurality of battery cells 110 in the Z-direction.

In one embodiment, the busbar frame 310 may include one or more third regions 301 and one or more fourth regions 302 alternately positioned along the stacking direction. Meanwhile, in one embodiment, one or more openings 305 may be respectively formed in the one or more third regions 301 of the busbar frame 310.

That is, in such an embodiment, the one or more openings 305 in the busbar frame 310 are formed only in the third region 301 and may not be formed in the fourth region 302. In other words, the region in which the openings 305 are formed in the busbar frame 310 may also be referred to as the third region 301.

Meanwhile, the third region 301 and the fourth region 302 may respectively refer to virtual regions arbitrarily set on the busbar frame 310. That is, the third region 301 and the fourth region 302 may be regions that are not physically divided or separated on the actual busbar frame 310. In other words, the boundaries of the third region 301 and the fourth region 302 may be virtual boundaries.

A more detailed description of the third region 301 and the fourth region 302 will be given later.

In one embodiment, one or more holes may be formed on the busbar frame 310 by the one or more openings 305. The openings 305 may be formed by perforating at least a portion of the busbar frame 310 into a predetermined shape using physical perforation means, a laser, or the like.

In one embodiment, the one or more openings 305 may each independently be formed in a shape of a circle, an ellipse, an oblong, or a quadrangle such as a parallelogram, a rectangle, a square, or a trapezoid. Meanwhile, the one or more openings 305 may each independently be formed in a quadrangular shape in which at least a part of the corners is rounded.

If necessary, the one or more openings 305 may all be formed in the same shape. Alternatively, if necessary, as illustrated in FIG. 8, they may be formed to be divided into two openings 305 having different areas.

A more detailed description of the one or more openings 305 will be given later.

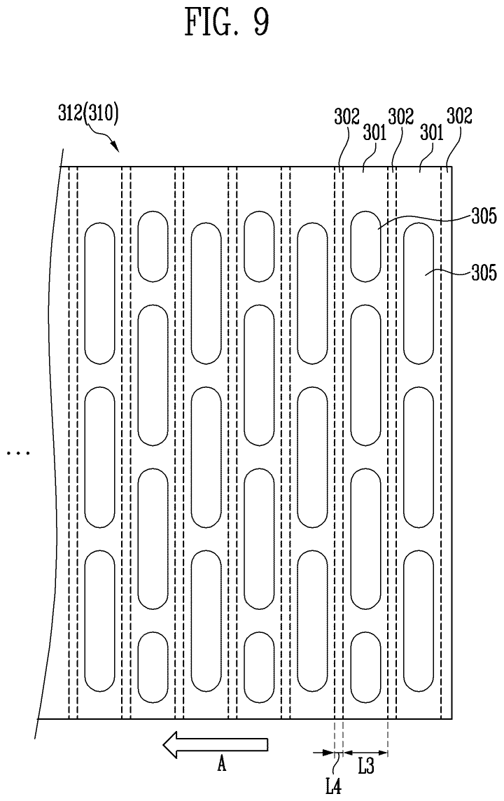

FIG. 9 illustrates an example of a region marked with B in a busbar assembly of FIG. 8 as viewed from one side.

Referring to FIG. 9, in one embodiment, the one or more third regions 301 may each have a third width L3 along the stacking direction, and the one or more fourth regions 302 may each have a fourth width L4 along the stacking direction.

As described above, the one or more third regions 301 and the one or more fourth regions 302 may be alternately positioned along the stacking direction on the busbar frame 310. Meanwhile, for example, with reference to FIG. 9, the one or more third regions 301 and the one or more fourth regions 302 may be alternately positioned along the A direction on the busbar frame 310. In this case, the A direction may be parallel to the stacking direction of the battery cell stack 100 in the battery assembly 10. That is, for example, with reference to FIG. 8, the A direction may be a direction parallel to the X direction.

In one embodiment, at least a portion of the one or more third regions 301 may have the third width L3 along the stacking direction, and at least a portion of the one or more fourth regions 302 may have the fourth width L4 along the stacking direction. In a specific embodiment, all of the one or more third regions 301 may have the third width L3 along the stacking direction, and at least a portion of the one or more fourth regions 302 may have the fourth width L4 along the stacking direction. In a more specific embodiment, all of the one or more third regions 301 may have the third width L3 along the stacking direction, and all of the one or more fourth regions 302 may have the fourth width L4 along the stacking direction, but the present invention is not necessarily limited thereto.

According to such an embodiment, the busbar frame 310 may be divided along the stacking direction into a sequence such as the fourth region 302-the third region 301-the fourth region 302-the third region 301- . . . -the fourth region 302. Meanwhile, in a specific embodiment, each of the third regions 301 divided as described above may have the third width L3. Meanwhile, in a specific embodiment, among the fourth regions 302 divided as described above, all of the fourth regions 302 except for the fourth regions 302 located at both ends may have the fourth width L4. Alternatively, each of the fourth regions 302 divided as described above may all have the fourth width L4.

In one embodiment, the busbar frame 310 may be divided into 25 virtual columns along the stacking direction. In this case, 12 third regions 301 and 13 fourth regions 302 may be alternately positioned along the stacking direction in the busbar frame 310.

In one embodiment, the busbar frame 310 may be divided into 37 virtual columns along the stacking direction. In this case, 18 third regions 301 and 19 fourth regions 302 may be alternately positioned along the stacking direction in the busbar assembly 300.

In one embodiment, the busbar frame 310 may be divided into 29 virtual columns along the stacking direction. In this case, 14 third regions 301 and 15 fourth regions 302 may be alternately positioned along the stacking direction in the busbar frame 310.

Referring again to FIG. 9, in one embodiment, the third width L3 may be 1.5 times to 3.5 times the fourth width L4.

In a specific embodiment, the third width L3 may be 1.5 times to 2.5 times the fourth width L4.

In a specific embodiment, the third width L3 may be 2.5 times to 3.5 times the fourth width L4.

In such an embodiment, as will be described below, the busbar frame 310 may be arranged such that at least one of the third regions 301 overlaps at least one of the first regions 201 of the pad 200, and at least one of the fourth regions 302 overlaps at least one of the second regions 202 of the pad 200. Referring to what has been described with reference to FIGS. 1 to 7, as a result, the busbar frame 310 may support or cover the battery cell stack 100 such that at least one of the third regions 301 overlaps the plurality of battery cells 110, and at least one of the fourth regions 302 overlaps the at least one barrier 120.

In one embodiment, a plurality of openings 305 may be respectively formed in the at least one third region 301.

In FIGS. 8 and 9, an example is illustrated in which three or four openings 305 are formed in each third region 301. However, this is an arbitrary matter, and as required, a variety of numbers of openings 305 of various shapes may be independently formed in each third region 301.

In one embodiment, the plurality of openings 305 may be formed in the at least one third region 301 along a direction perpendicular to the stacking direction.

In one embodiment, the entire area opened by the at least one opening 305 formed on the busbar frame 310 may be defined as a total opening area. Meanwhile, in one embodiment, the area opened by the at least one opening 305 formed on the busbar frame 310 may also be defined as a sum of unit opening areas that are divided according to a predetermined unit. In this case, the sum of the unit opening areas may be equal to the total opening area. In other words, the unit opening area may be equal to a value obtained by dividing the total opening area by the predetermined unit.

Meanwhile, in one embodiment, the total capacity of the plurality of battery cells 110 supported or covered by the busbar frame 310 may be defined as a reference capacity.

From this perspective, a value obtained by dividing the total opening area by the reference capacity may be defined as a capacity-area reference value. For example, the total opening area, the reference capacity, and the capacity-area reference value may satisfy a relationship defined by the following Equation 1.

$$X = A / C \qquad [ Equation 1 ]$$

In the above Equation 1, X is the capacity-area reference value (mm²/Ah), A is the total opening area (mm²), and C is the reference capacity (Ah).

In one embodiment, the capacity-area reference value may be a preset value. In other words, the capacity-area reference value may represent an arbitrary value set as needed.

As described above, the total opening area may be defined as the entire area opened by one or more openings 305 formed on the busbar frame 310. Therefore, the capacity-area reference value may represent an average battery capacity corresponding to each of the one or more openings 305. The capacity-area reference value, as described above, may indicate the opening ratio of the cover area relative to a unit battery cell 110 or relative to a logical unit, and in this context, may be used as an index indicating the venting ratio of heat, flame, and/or gas upward relative to a unit battery cell 110 or relative to a logical unit in the event of a thermal runaway situation.

By means of the preset capacity-area reference value, the total opening area by one or more openings 305 formed on the busbar frame 310 may be determined. That is, the sum of the areas of the one or more openings 305 formed on the busbar frame 310 may be determined by the capacity-area reference value.

Meanwhile, the area opened by one or more openings 305 formed on the busbar frame 310 may be defined as the sum of unit opening areas divided according to a preset unit, and as described above, the unit opening area may be the same as a value obtained by dividing the total opening area by the preset unit.

In one embodiment, the preset unit may be determined in relation to the number of logical units. That is, the unit opening area may be the same as a value obtained by dividing the total opening area by the number of logical units distinguished among the plurality of battery cells 110 supported or covered by the busbar frame 310.

In such an embodiment, the unit opening area may be defined as the sum of the opening areas of the openings 305 formed in a region of the busbar frame 310 supporting or covering any one logical unit of the battery cell stack 100. Meanwhile, referring to the matters described above with reference to FIGS. 1 to 9 and the matters to be described below regarding the arrangement relationship of the busbar assembly 300 and the pad 200, each of the one or more third regions 301 on the busbar frame 310 may be configured to overlap with any one of the logical units. As a result, the unit opening area may be defined as the sum of the opening areas of the openings 305 formed in any one of the third regions 301 on the busbar frame 310.

Accordingly, the unit opening area may be determined by the capacity-area reference value and the number of logical units. Meanwhile, since a plurality of openings 305 may be formed in the third region 301 as described above, each opening 305 may be formed by appropriately adjusting its position, spacing, and number according to the determined unit opening area.

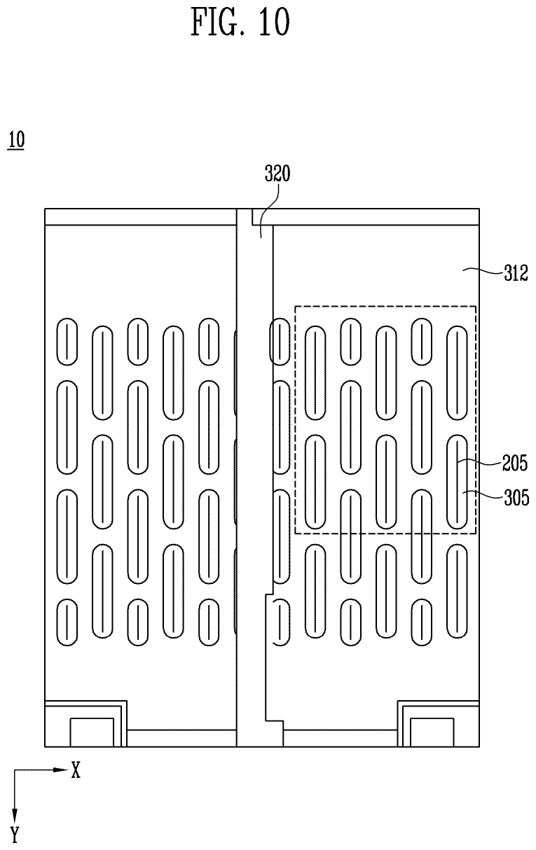

FIG. 10 illustrates an example of the battery assembly of FIG. 8 in a coupled state as viewed from a Z-direction.

In one embodiment, the busbar frame 310 may include a pair of first busbar frames 311 extending along the stacking direction, on which the busbars are mounted, and a second busbar frame 312 connecting the pair of first busbar frames 311. The one or more third regions 301 and the one or more fourth regions 302 may be located on the second busbar frame 312, and the pad 200 may be inserted such that the one or more first regions 201 overlap with the one or more third regions 301 and the one or more second regions 202 overlap with the one or more fourth regions 302.

Referring again to FIG. 8, in one embodiment, the first busbar frame 311 may extend along the stacking direction and the busbar may be mounted thereon. In an exemplary embodiment, the first busbar frame 311 may be configured such that a plurality of the busbars are mounted along the stacking direction. Meanwhile, the first busbar frame 311 may be configured as a pair positioned in the directions on both sides of the body portion of each battery cell 110 constituting the battery cell stack 100, so as to be connected with the lead tab portions 111 and 112 positioned at each side. Referring to the illustration in FIG. 8, for example, the first busbar frames 311 may each extend along the X-direction, and the first busbar frames 311 extending along the X-direction may be configured as a pair positioned at both ends in the Y-direction with respect to the battery cell stack 100.

Referring again to FIG. 8, in one embodiment, the second busbar frame 312 may connect the pair of first busbar frames 311. Referring to the illustration in FIG. 8, for example, the second busbar frame 312 may be configured to be parallel to the XY plane and to connect the pair of first busbar frames 311. Meanwhile, in this embodiment, the second busbar frame 312 may be configured and disposed to support or cover the battery cell stack 100 in the Z-direction, as will be described below.

In such an embodiment, the busbar frame 310 may be provided in an overall channel shape or U-shape.

In an exemplary embodiment, the pair of first busbar frames 311 and the second busbar frame 312 may be configured such that each separately formed structure is combined with each other through a separate coupling member. In contrast, in another exemplary embodiment, the pair of first busbar frames 311 and the second busbar frame 312 may be configured as an integrated structure.

Meanwhile, the busbar assembly 300 may further include a circuit member 320 configured, as necessary, to connect the plurality of battery cells 110 to an external device such as a Battery Management System (not shown), via the busbar. To this end, in an exemplary embodiment, the circuit member 320 may include a Flexible Printed Circuit Board (FPCB). Meanwhile, in an exemplary embodiment, the circuit member 320 may be formed on, or embedded in, the first busbar frame 311 and/or the second busbar frame 312.

Referring to FIGS. 8 and 10, in one embodiment, the one or more third regions 301 and the one or more fourth regions 302 may be located on the second busbar frame 312. In a specific embodiment, the one or more third regions 301 and the one or more fourth regions 302 may be located only on the second busbar frame 312.

As described above, the one or more openings 305 may be formed on the one or more third regions 301. Accordingly, in such an embodiment, the one or more openings 305 may be located on the second busbar frame 312, and in a specific embodiment, the one or more openings 305 may be formed only on the second busbar frame 312.

Meanwhile, as described above, in one embodiment, the pad 200 may be inserted between the battery cell stack 100 and the busbar frame 310 so as to cover the battery cell stack 100 on the one surface.

Meanwhile, referring to FIGS. 8 and 10, in one embodiment, the pad 200 may be inserted such that the one or more first regions 201 overlap with the one or more third regions 301, and the one or more second regions 202 overlap with the one or more fourth regions 302.

As described above with reference to FIG. 8, the busbar frame 310, specifically the second busbar frame 312, may be configured and arranged to support or cover the battery cell stack 100 in the one surface direction, specifically in the Z-direction of FIG. 8. Meanwhile, as described above with reference to FIGS. 1 to 7, the pad 200 may cover the battery cell stack 100 such that the one or more first regions 201 overlap with the plurality of battery cells 110, and the one or more second regions 202 overlap with the one or more barriers 120.

Accordingly, in one embodiment, the fact that the one or more third regions 301 overlap with the one or more first regions 201 of the pad 200 may mean that the pad 200 is inserted between the second busbar frame 312 and the battery cell stack 100 such that the one or more first regions 201 of the pad 200 are covered on one surface by the one or more third regions 301 of the second busbar frame 312. In an exemplary embodiment, the one or more first regions 201 of the pad 200 may be configured to contact the one or more third regions 301 of the second busbar frame 312 in the Z-direction. In a more specific embodiment, the entirety of the first region 201 of the pad 200 may overlap with the entirety of the third region 301 of the second busbar frame 312. In this case, each of the first regions 201 of the pad 200 may be configured to contact each of the third regions 301 of the second busbar frame 312 in the Z-direction.

Meanwhile, as described above, the one or more first regions 201 of the pad 200 may be configured to overlap with each logical unit of the battery cell stack 100. In such an embodiment, each first region 201 of the pad 200 may be configured to overlap with one logical unit, and each of the first regions 201 may be configured to overlap with each of the third regions 301 of the second busbar frame. In this case, one logical unit may be configured to be located on the same line as any one of the third regions 301 in the Z-direction.

Meanwhile, in one embodiment, the fact that the one or more fourth regions 302 overlap with the one or more second regions 202 of the pad 200 may mean that the pad 200 is inserted between the second busbar frame 312 and the battery cell stack 100 such that the one or more second regions 202 of the pad 200 are covered on one surface by the one or more fourth regions 302 of the second busbar frame 312. In an exemplary embodiment, the one or more second regions 202 of the pad 200 may be configured to contact the one or more fourth regions 302 of the second busbar frame 312 in the Z-direction. In a more specific embodiment, the entirety of the second region 202 of the pad 200 may overlap with the entirety of the fourth region 302 of the second busbar frame 312. In this case, each of the second regions 202 of the pad 200 may be configured to contact each of the fourth regions 302 of the second busbar frame 312 in the Z-direction.

In one embodiment, the first width L1 may be the same as the third width L3.

In one embodiment, the second width L2 may be the same as the fourth width L4.

In one embodiment, the arrangement of the first region 201 and the second region 202 located on the pad 200 and the arrangement of the third region 301 and the fourth region 302 located on the second busbar frame 312 may be the same.

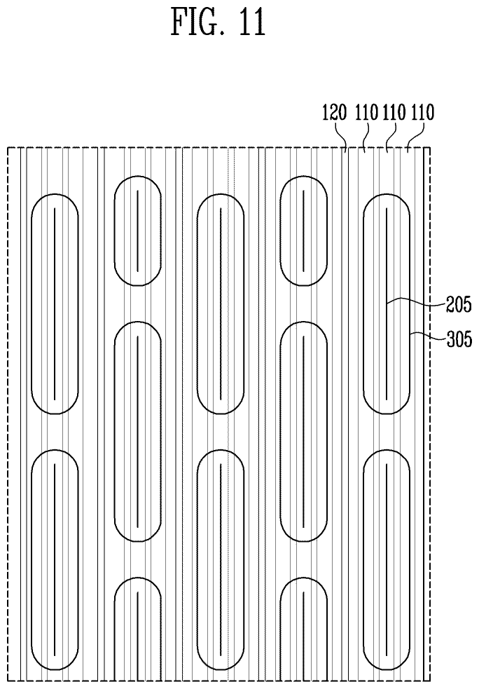

FIG. 11 illustrates an example of a region marked with C in the battery assembly of FIG. 10 in detail.

FIG. 11 is a view illustrating in detail an example of an arrangement relationship among the battery cell stack 100, the pad 200, and the second busbar frame 312 that overlap with each other.

Referring to FIG. 11, in one embodiment, the pad 200 may be inserted such that the one or more cut portions 205 formed in the pad 200 overlap with the one or more openings 305 formed in the busbar frame 310.

As described above with reference to FIGS. 1 to 6, the pad 200 may include one or more first regions 201 and one or more second regions 202 alternately positioned along the stacking direction, and one or more cut portions 205 may be respectively formed in the one or more first regions 201. Meanwhile, as described above with reference to FIGS. 8 to 10, the busbar frame 310, specifically the second busbar frame 312, may include one or more third regions 301 and one or more fourth regions 302 alternately positioned along the stacking direction, and one or more openings 305 may be respectively formed in the one or more third regions 301.

In one embodiment, the formation pattern of the one or more cut portions 205 formed in the pad 200 may be the same as the formation pattern of the one or more openings 305 formed in the busbar frame 310.

According to such an embodiment, in an arrangement relationship in which the pad 200 is disposed to cover one surface of the battery cell stack 100 and the second busbar frame 312 is positioned to support and cover one surface of the disposed pad 200 to support and cover the battery cell stack 100, each of the one or more cut portions 205 may contact each of the one or more openings 305 in the Z-direction.

Referring again to FIG. 11, in one embodiment, when the busbar frame 310 is orthographically projected onto the pad 200, the pad 200 may be inserted such that any one of the one or more cut portions 205 is included in any one of the one or more openings 305 that overlap therewith. In a specific embodiment, when the busbar frame 310 is orthographically projected onto the pad 200, the pad 200 may be inserted between the battery cell stack 100 and the busbar frame 310 such that each of the one or more cut portions 205 is included in a respective one of the one or more openings 305 that overlap therewith. Here, the busbar frame 310 may mean the second busbar frame 312, and as illustrated in FIG. 8, for example, the orthographic projection direction may be the Z-direction.

By such an embodiment, in one embodiment, the one or more cut portions 205 may be exposed to the outside through the one or more openings 305. In a specific embodiment, each of the one or more cut portions 205 may be exposed to the outside by a respective one of the one or more openings 305 that overlap therewith. Specifically, being “exposed to the outside” may mean that, when the battery assembly 10 including the above-described arrangement relationship of the battery cell stack 100, the pad 200, and the busbar frame 310 is viewed from a direction in which the openings 305 are formed, each of the cut portions 205 may be externally exposed so as to be visually observable.

As described above, the one or more cut portions 205 may be formed only in a region of the pad 200 that overlaps with the plurality of battery cells 110. In other words, in the battery assembly 10, the one or more cut portions 205 may be formed in a portion of the pad 200 that contacts the plurality of battery cells 110. More specifically, as described above, in the battery assembly 10, the one or more cut portions 205 may be formed in a portion of the pad 200 that contacts any one of the logical units. Meanwhile, each of the one or more cut portions 205 may be configured to be exposed to the outside by a respective opening 305 formed in the busbar assembly 300 covering the pad 200.

Accordingly, when at least one of the plurality of battery cells 110 ignites due to a short circuit, deterioration, or the like, thereby causing a thermal runaway situation, flames, heat, and/or high-pressure and high-temperature gas generated by the thermal runaway may pass through the pad 200 via the one or more cut portions 205 formed in the one or more first regions 201 that are positioned to overlap with the plurality of battery cells 110, and may be discharged to the outside through the respective openings 305 positioned to overlap with the respective cut portions 205. Therefore, in the event of a thermal runaway, the battery assembly 10 may control the path of the flames, heat, and/or high-pressure and high-temperature gas directed from the battery cell stack 100 toward the one side direction to a predetermined path, thereby discharging them through a specific path. Furthermore, in the event of a thermal runaway, since the pad 200 is configured to cover the one side, the flames, heat, and/or high-pressure and high-temperature gas may be constrained by the pad 200 in the direction toward the one side (the Z-direction in FIGS. 1 and 8) of the battery cell stack 100, thereby preventing the phenomenon in which thermal propagation between the battery cells 110 and/or between the logical units is accelerated. Accordingly, in addition to preventing foreign matter from penetrating into the inside of the battery cell stack 100 and ensuring insulation by the pad 200, safety in the event of a thermal runaway may also be further improved.

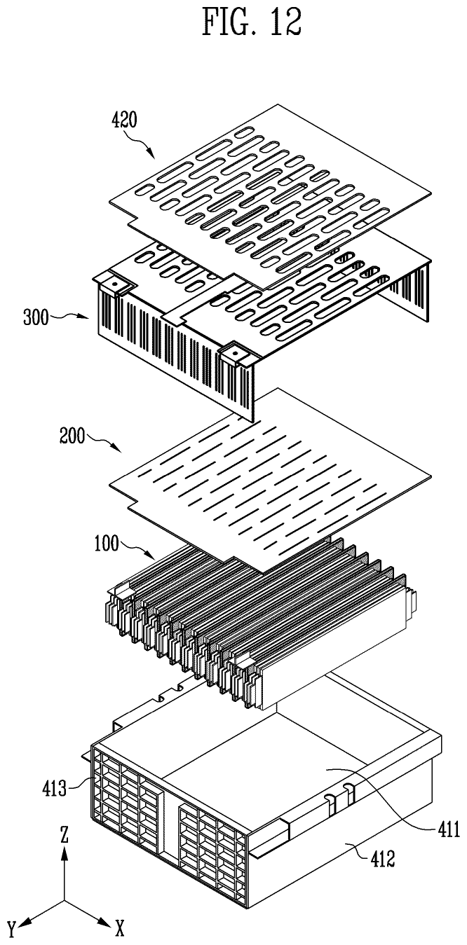

FIG. 12 illustrates another example of an arrangement relationship among components constituting a battery assembly according to an embodiment of the present disclosure.

Referring to FIG. 12, in one embodiment, the battery assembly 10 may further include a receiving cover 420 coupled to the receiving body 410 to cover the opened one side, wherein the receiving cover 420 includes one or more fifth regions 421 and one or more sixth regions 422 alternately positioned along the stacking direction of the plurality of battery cells 110, one or more openings 425 being respectively formed in the one or more fifth regions 421, and the pad 200 may be inserted between the battery cell stack 100 and the receiving cover 420 so as to cover the battery cell stack 100 at the one side.

In one embodiment, the receiving cover 420 may be coupled to the receiving body 410 to cover the opened one side of the receiving body 410. In one embodiment, the receiving cover 420 may form the receiving space together with the receiving body 410. Meanwhile, as described above, the receiving cover 420, together with the receiving body 410, may define a receiving case 400 that accommodates the battery cell stack 100. By the configuration of the receiving case 400 as described above, the function of protecting the battery cell stack 100 from external impacts such as vibration may be performed.

In one embodiment, the receiving body 410 may be coupled with the receiving cover 420. In a specific embodiment, the receiving cover 420 may be coupled so as to be positioned parallel to the body bottom side 411. In a specific embodiment, the corners of the end plate 413 and the body side portion 412 at positions coupled with the body bottom side 411 may face corresponding corners of the receiving cover 420 to be respectively coupled thereto. By such a configuration, the receiving cover 420 may be configured to cover the opened one side of the receiving body 410.

In one embodiment, the receiving space may accommodate the battery cell stack 100, the pad 200, and the busbar assembly 300 in the arrangement described above.

In one embodiment, the pad 200 described with reference to FIGS. 1 to 7 may be inserted between the battery cell stack 100 and the receiving cover 420 so as to cover the battery cell stack 100 at the one side.

Meanwhile, in one embodiment, the busbar assembly 300 described with reference to FIGS. 8 to 11 may be included to support the battery cell stack 100 from the one side direction. In this case, the pad 200 may be configured to be inserted between the battery cell stack 100 and the busbar frame 310 of the busbar assembly 300 as described above, and the pad 200 and the busbar frame 310 may be configured to be positioned between the battery cell stack 100 and the receiving cover 420. That is, based on what is shown in FIG. 12, for example, the receiving cover 420 may also perform a role of supporting the busbar assembly 300 in the Z-direction.

In one embodiment, the receiving cover 420 may include one or more fifth regions 421 and one or more sixth regions 422 alternately positioned along the stacking direction. Meanwhile, in one embodiment, one or more openings 425 may be respectively formed in the one or more fifth regions 421 of the receiving cover 420.

That is, in such an embodiment, the openings 425 in the receiving cover 420 may be formed only in the fifth regions 421, and may not be formed in the sixth regions 422. In other words, in the receiving cover 420, the region where the openings 425 are formed may also be referred to as the fifth region 421.

Meanwhile, the fifth region 421 and the sixth region 422 may respectively mean virtual regions arbitrarily set on the receiving cover 420. That is, the fifth region 421 and the sixth region 422 may be regions that are not physically divided or distinguished on the actual receiving cover 420. In other words, the boundaries of the fifth region 421 and the sixth region 422 may be virtual boundaries.

A more detailed description of the fifth region 421 and the sixth region 422 will be given below.

In one embodiment, one or more holes may be formed on the receiving cover 420 by the one or more openings 425. The openings 425 may be formed by perforating at least a part of the receiving cover 420 into a predetermined shape using a physical perforation member, a laser, or the like.

In addition, with respect to the shape and formation aspect of the one or more openings 425, the matters described with reference to FIGS. 8 to 11 above may be equally applied. Hereinafter, with respect to the one or more openings 425, redundant description will be omitted.

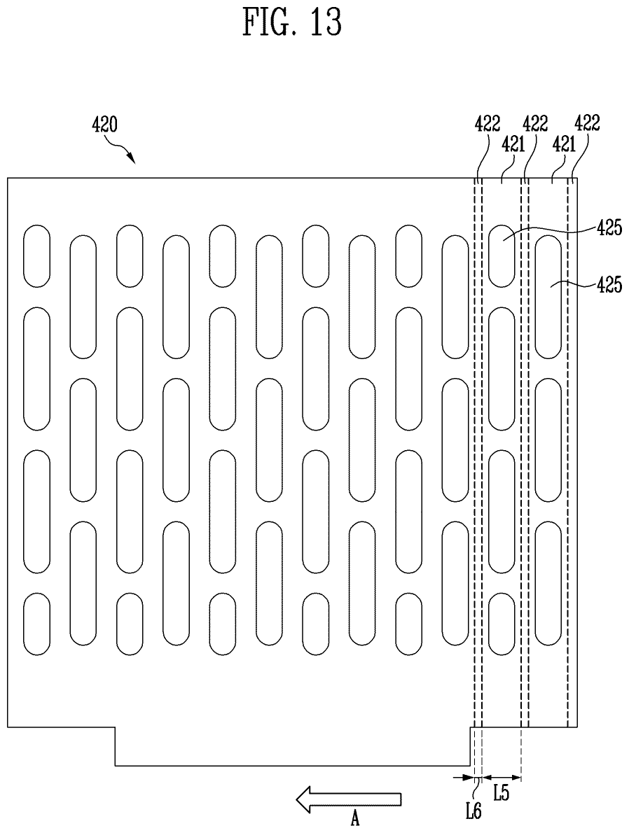

FIG. 13 illustrates an example of a receiving cover according to an embodiment of the present disclosure as viewed from one direction.

Referring to FIG. 13, in one embodiment, the one or more fifth regions 421 may each have a fifth width L5 along the stacking direction, and the one or more sixth regions 422 may each have a sixth width L6 along the stacking direction.

As described above, the one or more fifth regions 421 and the one or more sixth regions 422 may be alternately positioned along the stacking direction on the receiving cover 420. Meanwhile, referring to FIG. 13, for example, the one or more fifth regions 421 and the one or more sixth regions 422 may be alternately positioned along the A direction on the receiving cover 420. In this case, the A direction may be parallel to the stacking direction of the battery cell stack 100 in the battery assembly 10. That is, when referring to FIG. 12, it may be a direction parallel to the X direction.

In one embodiment, at least a portion of the one or more fifth regions 421 may have a fifth width L5 along the stacking direction, and at least a portion of the one or more sixth regions 422 may have a sixth width L6 along the stacking direction. In a specific embodiment, all of the one or more fifth regions 421 may have a fifth width L5 along the stacking direction, and at least a portion of the one or more sixth regions 422 may have a sixth width L6 along the stacking direction. In a more specific embodiment, all of the one or more fifth regions 421 may have a fifth width L5 along the stacking direction, and all of the one or more sixth regions 422 may have a sixth width L6 along the stacking direction, but are not necessarily limited thereto.

According to such an embodiment, the receiving cover 420 may be divided along the stacking direction into a sequence such as the sixth region 422-the fifth region 421-the sixth region 422-the fifth region 421- . . . -the sixth region 422. Meanwhile, in a specific embodiment, each of the fifth regions 421 divided as described above may all have the fifth width L5. In a specific embodiment, among the sixth regions 422 divided as described above, all of the sixth regions 422 except for the sixth regions 422 located at both ends may have the sixth width L6. Alternatively, each of the sixth regions 422 divided as described above may all have the sixth width L6.

In one embodiment, the receiving cover 420 may be divided into 25 virtual columns along the stacking direction. In this case, the receiving cover 420 may have 12 fifth regions 421 and 13 sixth regions 422 alternately positioned along the stacking direction.

In one embodiment, the receiving cover 420 may be divided into 37 virtual columns along the stacking direction. In this case, the receiving cover 420 may have 18 fifth regions 421 and 19 sixth regions 422 alternately positioned along the stacking direction.

In one embodiment, the receiving cover 420 may be divided into 29 virtual columns along the stacking direction. In this case, the receiving cover 420 may have 14 fifth regions 421 and 15 sixth regions 422 alternately positioned along the stacking direction.

Referring again to FIG. 13, in one embodiment, the fifth width L5 may be 1.5 times to 3.5 times the sixth width L6.

In a specific embodiment, the fifth width L5 may be 1.5 times to 2.5 times the sixth width L6.

In a specific embodiment, the fifth width L5 may be 2.5 times to 3.5 times the sixth width L6.

In such an embodiment, as will be described later, the receiving cover 420 may be arranged such that at least one of the fifth regions 421 overlaps with at least one of the first regions 201 of the pad 200, and at least one of the sixth regions 422 overlaps with at least one of the second regions 202 of the pad 200. Referring to the foregoing description with reference to FIGS. 1 to 7, consequently, the receiving cover 420 may support or cover the battery cell stack 100 such that at least one of the fifth regions 421 overlaps with the plurality of battery cells 110 and at least one of the sixth regions 422 overlaps with the at least one barrier 120.

In one embodiment, a plurality of openings 425 may be respectively formed in the at least one fifth region 421.

In FIGS. 12 and 13, an example is illustrated in which three or four openings 425 are formed in each of the fifth regions 421. However, this is an arbitrary matter, and as needed, a variety of numbers of openings 425 may be independently formed in each of the fifth regions 421 in various shapes.

In one embodiment, in the at least one fifth region 421, the plurality of openings 425 may be formed along a direction perpendicular to the stacking direction.

Meanwhile, as described above, in one embodiment, the pad 200 may be inserted between the battery cell stack 100 and the receiving cover 420 so as to cover the battery cell stack 100 from the one side. In a specific embodiment, as described above, the battery assembly 10 may include the busbar assembly 300 as described above, and the battery cell stack 100, the pad 200, and the busbar assembly 300 may be configured in the receiving space in the arrangement manner described above. In this case, the pad 200 may be inserted between the battery cell stack 100 and the busbar assembly 300, specifically between the battery cell stack 100 and the busbar frame 310, and the receiving cover 420 may cover the receiving space at an outer side of the busbar frame 310.

In one embodiment, the pad 200 may be inserted such that the one or more first regions 201 overlap with the one or more fifth regions 421, and the one or more second regions 202 overlap with the one or more sixth regions 422.

With reference to FIG. 12, as described above, the receiving cover 420 may cover the receiving space in the Z direction of FIG. 12. Meanwhile, as described with reference to FIGS. 1 to 7, the pad 200 may cover the battery cell stack 100 such that the one or more first regions 201 overlap with the plurality of battery cells 110, and the one or more second regions 202 overlap with the one or more barriers 120.

Therefore, in one embodiment, the one or more fifth regions 421 overlapping with the one or more first regions 201 of the pad 200 means that the one or more first regions 201 of the pad 200 are configured to be positioned together on the same line in the Z direction with the one or more fifth regions 421 of the receiving cover 420. In a specific embodiment, all of the first regions 201 of the pad 200 may overlap with all of the fifth regions 421 of the receiving cover 420 in the above-described manner. In this case, each of the first regions 201 of the pad 200 may be configured to be positioned together on the same line in the Z direction with each of the fifth regions 421 of the receiving cover 420.

Meanwhile, as described above, the one or more first regions 201 of the pad 200 may be configured to overlap with each logical unit of the battery cell stack 100. In such an embodiment, each of the first regions 201 of the pad 200 may be configured to overlap with one of the logics, and each of the first regions 201 may be configured to overlap with each of the fifth regions 421 of the receiving cover. In this case, one of the logics may be configured to be positioned together on the same line in the Z direction with one of the fifth regions 421.

Meanwhile, in another embodiment, the receiving cover 420 may cover the receiving space such that one or more fifth regions 421 overlap with one or more third regions 301 of the busbar frame 310, and one or more sixth regions 422 overlap with one or more fourth regions 302 of the busbar frame 310.

Referring to the arrangement relationship of the battery cell stack 100, the pad 200, the busbar assembly 300, and the receiving cover 420 described with reference to FIGS. 1 to 12, the one or more fifth regions 421 overlapping with the one or more third regions 301 of the busbar frame 310 means that one or more third regions 301 of the busbar frame 310 are configured to contact one or more fifth regions 421 of the receiving cover 420 in the Z direction. In a more specific embodiment, all of the third regions 301 of the busbar frame 310 may overlap with all of the fifth regions 421 of the receiving cover 420, and in this case, each of the third regions 301 of the busbar frame 310 may be configured to contact each of the fourth regions 302 of the receiving cover 420 in the Z direction.

Referring to the above-described matters, the arrangement relationship between the sixth region 422 of the receiving cover 420 and the second region 202 of the pad 200, and furthermore, the arrangement relationship with the fourth region 302 of the busbar frame 310 can also be explained similarly; therefore, redundant description will be omitted hereinafter.

In one embodiment, the first width L1 may be equal to the fifth width L5.

In one embodiment, the second width L2 may be equal to the sixth width L6.

In one embodiment, the first width L1, the third width L3, and the fifth width L5 may all be equal.

In one embodiment, the second width L2, the fourth width L4, and the sixth width L6 may all be equal.

In one embodiment, the arrangement pattern of the first region 201 and the second region 202 located on the pad 200 may be the same as the arrangement pattern of the third region 301 and the fourth region 302 located on the second busbar frame 312.

In one embodiment, the arrangement pattern of the first region 201 and the second region 202 located on the pad 200, the arrangement pattern of the third region 301 and the fourth region 302 located on the second busbar frame 312, and the arrangement pattern of the fifth region 421 and the sixth region 422 located on the receiving cover 420 may all be the same.

In one embodiment, the pad 200 may be inserted so that the one or more cutting portions 205 formed in the pad 200 overlap with the one or more openings 425 formed in the receiving cover 420.

In one embodiment, the formation pattern of the one or more cutting portions 205 formed in the pad 200 may be identical to the formation pattern of the one or more openings 425 formed in the receiving cover 420.

Meanwhile, referring to the above description with reference to FIGS. 8 to 11, the one or more cutting portions 205 formed in the pad 200 may be formed to overlap the one or more openings 305 formed in the busbar frame 310. In this case, the one or more openings 305 formed in the busbar frame 310 may in turn overlap the one or more openings 425 formed in the receiving cover 420, thereby constituting the battery assembly 10.

In such an embodiment, the formation pattern of the one or more cutting portions 205 formed in the pad 200 may be identical to both the formation pattern of the one or more openings 305 formed in the busbar frame 310 and the formation pattern of the one or more openings 425 formed in the receiving cover 420.

In such an embodiment, due to the above-described arrangement, each of the one or more cutting portions 205 contacts each of the one or more openings 305 formed in the busbar frame 310 in the Z direction, and simultaneously, each of the one or more openings 305 formed in the busbar frame 310 contacts each of the one or more openings 425 formed in the receiving cover 420 in the Z direction.

In one embodiment, when the receiving cover 420 is orthogonally projected onto the pad 200, any one of the one or more cutting portions 205 may be inserted so as to be included in any one of the one or more openings 425 that overlap. In a specific embodiment, when the receiving cover 420 is orthogonally projected onto the pad 200, each of the one or more cutting portions 205 may be included in each of the corresponding overlapping openings 425, so that the pad 200 may be inserted between the battery cell stack 100 and the receiving cover 420. As described above with reference to FIG. 8, the orthogonal projection direction may be the Z direction.

According to such an embodiment, in one embodiment, the one or more cutting portions 205 may be exposed to the outside through the one or more openings 425. In a specific embodiment, each of the one or more cutting portions 205 may be exposed to the outside by each of the overlapping openings 425. Specifically, “exposed to the outside” means that, when viewing the battery assembly 10—including the battery cell stack 100, pad 200, and receiving cover 420 arranged as described above—from the direction where the openings 425 are formed, each cutting portion 205 can be visually observed with the naked eye and thus exposed to the outside.

Meanwhile, as described above with reference to FIGS. 8 to 13, the battery assembly 10 including the battery cell stack 100, pad 200, busbar assembly 300, and receiving cover 420 arranged as described above may also be exposed to the outside such that each cutting portion 205 can be visually observed with the naked eye when viewed from the direction where the openings 425 are formed. This is because, as described above, each of the one or more cutting portions 205 overlaps with each of the one or more openings 305 formed in the busbar assembly 300, and each of the one or more openings 305 overlaps with each of the one or more openings 425 formed in the receiving cover 420. As a result, each cutting portion 205 can be exposed to the outside such that it can be visually observed.

Accordingly, when at least one of the plurality of battery cells 110 ignites due to short circuit, deterioration, or the like, causing a thermal runaway situation, the flames, heat, and/or high-pressure and high-temperature gases generated by the thermal runaway pass through the one or more cutting portions 205 formed in the one or more first regions 201 overlapping with the plurality of battery cells 110, passing through the pad 200, and then sequentially pass through each of the openings 305 and 425 positioned to overlap with each cutting portion 205, to be discharged to the outside. Therefore, the battery assembly 10 can control the path of the flames, heat, and/or high-pressure and high-temperature gases moving from the battery cell stack 100 toward the one surface direction to a predetermined path and discharge them along a specific route in the event of a thermal runaway situation. Furthermore, by configuring the pad 200 to cover the one surface, the flames, heat, and/or high-pressure and high-temperature gases are confined by the pad 200 toward the one surface (Z direction in FIGS. 1 and 8) of the battery cell stack 100, thereby preventing accelerated thermal propagation between battery cells 110 and/or between logical units. As a result, the pad 200 not only prevents foreign substance intrusion and secures insulation inside the battery cell stack 100 but also further improves safety during thermal runaway situations.

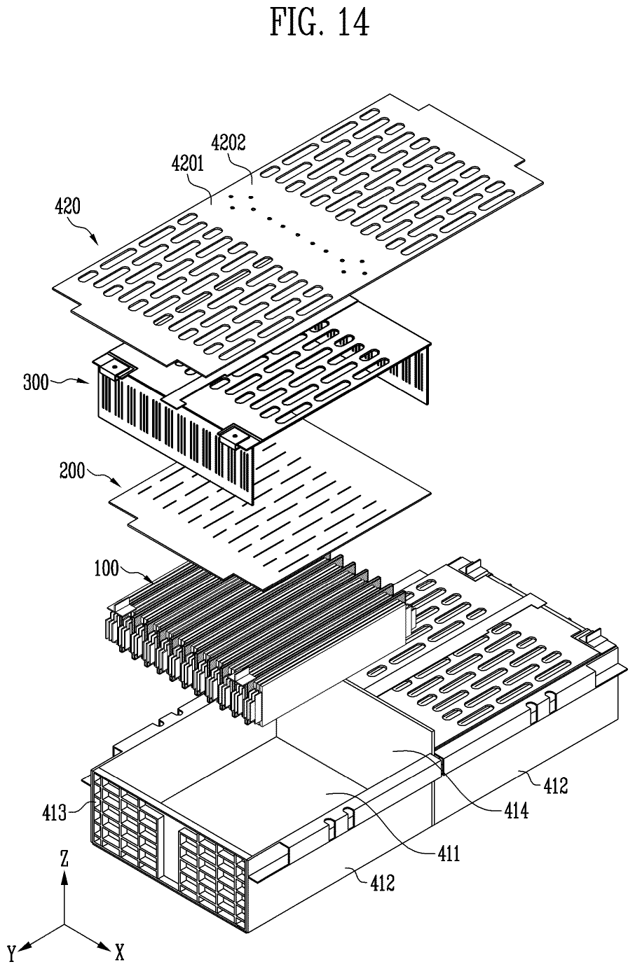

FIG. 14 illustrates another example of an arrangement relationship among components constituting a battery assembly according to an embodiment of the present disclosure.

FIG. 14 illustrates a battery assembly according to another exemplary embodiment of the present disclosure.

In one exemplary embodiment, the battery assembly 10 includes the configuration of the receiving case 400 and further includes a center frame 414 that partitions the receiving space at the center of the receiving case 400.

In such an embodiment, the receiving space can be divided by the center frame 414 into a first receiving space and a second receiving space, and each of the first receiving space and the second receiving space can be respectively equipped with the battery cell stack 100 and the busbar assembly 300 as described above.

Meanwhile, in one exemplary embodiment, the center frame 414 may be additionally provided with various functional configurations such as a cooling channel or a thermal blocking member, but is not necessarily limited thereto.

In one exemplary embodiment, the receiving cover 420 may be divided into a first sub-region 4201 and a second sub-region 4202, where the first sub-region 4201 and the second sub-region 4202 have one or more fifth regions 421 and one or more sixth regions 422 alternately arranged as described above, and one or more openings 425 may be formed in the one or more fifth regions 421. The arrangement relationship among the pad 200, the busbar assembly 300, and the receiving cover 420 can be configured in the same manner as described above.

The battery assembly according to one exemplary embodiment of the present disclosure can be preferably used not only as a power source for small devices but also as a power source for medium- to large-sized devices. Examples of the small devices include mobile phones, laptop computers, cameras, and the like, and examples of the medium- to large-sized devices include electric vehicles, hybrid electric vehicles, plug-in hybrid electric vehicles, power storage systems, and the like, but the present disclosure is not limited to these.

Hereinafter, the embodiments of the present disclosure will be further described with reference to specific experimental examples. The embodiments and comparative examples included in the experimental examples are only illustrative of the present invention and do not limit the appended claims. It is apparent to those skilled in the art that various modifications and changes can be made to the embodiments within the scope and spirit of the present disclosure, and such modifications and changes naturally fall within the scope of the appended claims.

### Embodiment

### Example

Thirty-six pouch-type battery cells were prepared, and mica material barriers were inserted at a ratio of one barrier per three battery cells, thereby preparing a logical unit battery cell stack comprising twelve battery cells. A heating pad was attached to the main room of the first battery cell in the stacking direction of the battery cells.

A busbar assembly including a busbar frame having a plurality of openings formed on the upper surface along one direction was prepared. The prepared state of the busbar assembly was as shown in FIG. 8.

A sheet-type polyurethane pad was prepared. Using a knife mold, multiple cutting portions were simultaneously formed on the prepared pad, which was then cut into a predetermined shape. The prepared polyurethane pad was as shown in FIG. 8.

The prepared battery cell stack set was connected to the busbar assembly prepared above, and the prepared polyurethane pad was inserted into the space separated between the busbar assemblies on the upper surface of the battery cell stack. At this time, the openings formed in the busbar frame and the cutting portions formed in the pad were aligned with each other. The assembly was then accommodated in the receiving space of a pre-prepared receiving case, thereby preparing the battery module.

### Comparative Example

Except that multiple cutting portions were not formed in the polyurethane pad, the battery module was prepared by the same method as in the Example.

### Evaluation Example

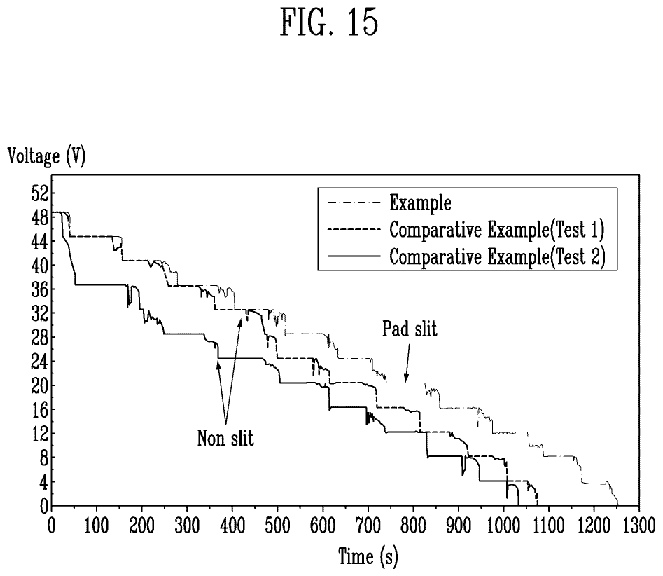

FIG. 15 illustrates a graph showing a voltage drop over time of each of an embodiment and a comparative example of a battery module in a thermal runaway simulation.

The battery modules of the Example and Comparative Example were inserted into a testing jig, and the heating pads attached to the first battery cell of each module were heated to simulate a thermal runaway situation. For the Comparative Example battery module, the test was conducted twice under the same conditions to verify repeatability.

Referring to FIG. 15, the evaluation results confirmed that, during the thermal runaway simulation, the battery module of the Example exhibited approximately a 17% delay effect in thermal runaway time compared to the battery module of the Comparative Example. This is attributed to the fact that the battery module of the Example includes a pad with multiple cutting portions positioned on the upper surface of the battery cell stack, and the multiple cutting portions are designed to be aligned and communicate with openings in the busbar frame and the receiving cover that are on the same line. As a result, flames and gases generated toward the battery cell stack can be easily discharged upward, mitigating heat transfer between logical units.

The above-described content is merely an example applying the principle of the present disclosure, and other configurations may be included within the scope of the present disclosure without departing from its scope.

What is claimed is:

1. An assembly comprising:
a battery cell stack comprising a plurality of battery cells;
a receiving body configured to retain the battery cell stack, the receiving body comprising a receiving space having at least one open side; and
a pad positioned adjacent to the battery cell stack at the one open side.

2. The assembly according to claim 1, wherein the pad is configured to cover the battery stack at the one open side and comprises one or more first regions and one or more second regions, wherein one or more cut portions are respectively formed in the one or more first regions.

3. The assembly according to claim 2, wherein the one or more first regions and the one or more second regions are alternately positioned along a stacking direction of the plurality of battery cells.

4. The assembly according to claim 3, wherein each of the one or more first regions has a first width along the stacking direction, and each of the one or more second regions has a second width along the stacking direction.

5. The assembly according to claim 4, wherein the first width is 1.5 times to 3.5 times the second width.

6. The assembly according to claim 2, wherein the one or more cut portions comprise a plurality of cut portions in the one or more first regions.

7. The assembly according to claim 1, wherein each of the one or more cut portions is independently formed in a continuous shape or a discontinuous shape.

8. The assembly according to claim 1, wherein the battery cell stack further comprises one or more barriers respectively inserted between any two adjacent battery cells among the plurality of battery cells, and the pad covers the battery cell stack such that the one or more first regions overlap the plurality of battery cells and the one or more second regions overlap the one or more barriers.

9. The assembly according to claim 1, further comprising:
a busbar assembly comprising a busbar electrically connecting the plurality of battery cells; and
a busbar frame supporting the busbar,
wherein the busbar frame comprises one or more third regions and one or more fourth regions alternately positioned along a stacking direction of the plurality of battery cells, and one or more openings are respectively formed in the one or more third regions,
wherein the pad is inserted between the battery cell stack and the busbar frame to cover the battery cell stack at the one open side.

10. The assembly according to claim 9, wherein each of the one or more third regions has a third width along the stacking direction, and each of the one or more fourth regions has a fourth width along the stacking direction.

11. The assembly according to claim 10, wherein the third width is 1.5 times to 3.5 times the fourth width.

12. The assembly according to claim 9, wherein the one or more openings include a plurality of openings respectively formed in the one or more third regions.

13. The assembly according to claim 9, wherein the busbar frame comprises a pair of first busbar frames extending along the stacking direction and on which the busbar is mounted, and a second busbar frame connecting the pair of first busbar frames, wherein the one or more third regions and the one or more fourth regions are located on the second busbar frame,
wherein the pad is inserted such that the one or more first regions overlap the one or more third regions and the one or more second regions overlap the one or more fourth regions.

14. The assembly according to claim 9, wherein the pad is inserted such that the one or more cut portions formed in the pad overlap the one or more openings formed in the busbar frame.

15. The assembly according to claim 14, wherein the pad is inserted such that, when orthographically projected onto the pad, any one of the one or more cut portions is included in any one of the one or more openings that overlap.

16. The assembly according to claim 9, wherein the one or more cut portions are exposed to the outside through the one or more openings.

17. The assembly according to claim 1, further comprising a receiving cover coupled to the receiving body and covering the one open side,
wherein the receiving cover comprises one or more fifth regions and one or more sixth regions alternately positioned along a stacking direction of the plurality of battery cells, and one or more openings are respectively formed in the one or more fifth regions,
wherein the pad is inserted between the battery cell stack and the receiving cover to cover the battery cell stack at the one open side.

18. The assembly according to claim 17, wherein the pad is inserted such that the one or more first regions overlap the one or more fifth regions, and the one or more second regions overlap the one or more sixth regions.

19. The assembly according to claim 17, wherein the pad is inserted such that the one or more cut portions formed in the pad overlap the one or more openings formed in the receiving cover.

20. The assembly according to claim 19, wherein the pad is inserted such that, when the receiving cover is orthographically projected onto the pad, any one of the one or more cut portions is included in any one of the one or more openings that overlap.

21. The assembly according to claim 17, wherein the one or more cut portions are exposed to the outside through the one or more openings.

22. An apparatus for mitigating heat or flame damage to a battery assembly in the event of a thermal runaway, comprising:
a pad configured to cover a battery cell stack at an open side of a receiving body;
wherein the pad comprises one or more first regions and one or more second regions, wherein one or more cut portions are respectively formed in the one or more first regions.
